(19) United States
(12) Patent Application Publication
(10) Pub. No.: US 2026/0126816 A1
(43) Pub. Date: May 7, 2026

(54) METHODS AND SYSTEMS FOR IMPROVED OPERATION OF A WORKING VEHICLE

(71) Applicant: Sabanto, Inc., Itasca, IL (US)

(72) Inventors: Ravi Yenduri, Itasca, IL (US); Corwin Spaetti, Ames, IA (US); Michael Joseph Lyons, Spring Hill, TN (US); Chris Mikelson, Ames, IA (US); Craig Rupp, Ames, IA (US)

(73) Assignee: Sabanto, Inc., Itasca, IL (US)

(21) Appl. No.: 19/370,359

(22) Filed: Oct. 27, 2025

Related U.S. Application Data
(60) Provisional application No. 63/713,662, filed on Oct. 30, 2024.

(51) Int. Cl. G05D 1/693; G05D 1/248; G05D 1/633; G05D 105/15; G05D 107/20; G05D 109/10; G05D 111/30; H04W 4/021; H04W 4/029; H04W 4/44

(52) U.S. Cl. CPC G05D 1/693; G05D 1/248; G05D 1/633; H04W 4/021; H04W 4/029; H04W 4/44; G05D 2105/15; G05D 2107/21; G05D 2109/10; G05D 2111/30

(57) ABSTRACT

Methods for improved operation of vehicles in a work area are provided. A method for autonomously moving a vehicle between disjoint work areas involves following a transit path, keeping the vehicle within a geofence around the transit path, and stopping for situational assessment if an obstacle is encountered. A method for providing real-time navigation updates based on moving obstacles in a work area updates a route plan for a target vehicle based on the predicted speed and trajectory of other vehicles and obstacles. A method for proximity based pausing of autonomous vehicles pauses vehicles when distance between them becomes less than a defined threshold and manually resumes the vehicles under modified route plans

### CROSS-REFERENCE TO RELATED APPLICATIONS

This application claims priority to U.S. Provisional Paten Application No. 63/713,662, filed on Oct. 30, 2024, the entirety of which is hereby incorporated herein by reference.

### FIELD OF THE INVENTION

The disclosure relates generally to methods and systems for improved operation of a working vehicle. In particular, in one embodiment, the disclosure provides for a method for autonomously moving a vehicle between disjoint work areas. In another embodiment, the disclosure provides for a method and system for providing real time navigation updates based on moving obstacles in a work area. In another embodiment, the disclosure provides for a method for avoiding collisions between multiple autonomous vehicles.

### BACKGROUND OF THE INVENTION

Many issues are encountered during operation of a working vehicle such as an agricultural vehicle whether those operations are performed using a manned vehicle or by an autonomous or remotely controlled vehicle.

The time and effort needed to move farm equipment between fields significantly affects agricultural productivity. Traditionally, farmers have manually driven equipment between fields, relying on their own skills and availability. However, manual transit requires significant human labor, is inefficient in terms of time and resource allocation, and can lead to operator fatigue, increasing the risk of accidents. Recently, semi-autonomous systems autonomously steer or follow a path for work operations within a field, but human supervision is required, particularly for complex tasks like transitioning between fields. Overall, the existing methods for moving vehicles between disjoint fields are slow, require a lot of resources, and can lead to mistakes since they involve human involvement. In big farming operations where fields are spread out, this process requires careful coordination. When large vehicles like tractors are driven on public roads or across different terrains, safety is also a concern. Therefore, an improved method for moving autonomous vehicles between disjoint work areas is desired.

Another issue encountered by working vehicles relates to path planning in the presence of moving obstacles. Current route planning algorithms for autonomous or semi-autonomous systems, especially in large-scale agriculture, manufacturing, or logistics, struggle with dynamic obstacle avoidance. Specifically, pivoting machinery or movable obstacles in a work area can disrupt the planned routes of autonomous vehicles or equipment, leading to inefficiencies or potential collisions. This issue becomes more pronounced in environments where the positions of such obstacles change frequently and unpredictably. One current approach to the problem is static mapping, which relies on default maps assuming fixed constraints, and does not account for dynamic changes. Static mapping fails in environments or areas where obstacles are not fixed. Another current approach is sensor-based detection, which uses real-time sensors like LIDAR or ultrasonic sensors to detect obstacles. The shortcoming of sensor-based detection is that it can only react to obstacles once they are detected, potentially leading to delays or the need for sudden route changes. Another approach to the problem is RFID or beacon-based systems in which static and semi-static obstacles are marked with RFID tags or beacons for identification. RFID or beacon-based systems provide some level of dynamic obstacle tracking, but lack precise, real-time positioning and movement prediction, limiting their effectiveness in fast-paced or highly variable environments. Therefore, a system and method for providing real-time navigation updates based on moving obstacles in a work area are desired.

Another issue that arises with working vehicles relates to avoiding collisions when multiple autonomous vehicles are operating in a work area. Current collision detections systems utilize multiple sensor technologies; however, these approaches require a lot of integration at all levels of the technology stack (i.e., the device level, front end configuration, and back end synchronization). Therefore, an improved method for collision avoidance between autonomous working vehicles is desired.

### SUMMARY OF THE INVENTION

In accordance with various embodiments of the invention, improved methods for directing the operation of working vehicles are provided.

In one embodiment, a method for autonomously moving a vehicle between disjoint work areas is provided. A vehicle that is to be moved from one work area to another enters transport mode in which any implement associated with the vehicle is secured for transport. A pre-recorded or dynamically created transit path is loaded, and a geofence is defined around the transit path. While the vehicle remains within the geofence, the transit path is followed, correcting course as necessary to remain within the geofence. The vehicle continues following the transit path until a boundary is reached. When a boundary is reached, the vehicle stops and performs situational assessment. When safe to proceed, the vehicle moves into the new work area. If situational assessment determines that it is not safe to proceed, the vehicle pauses for human intervention.

In another embodiment, a method for providing real-time navigation updates based on moving obstacles in a work area is provided. A plurality of vehicles, each equipped with a computer, GNSS unit, and communication system, is provided. A route plan is executed by a target vehicle that is implementing the method. The target vehicle receives the locations of other vehicles and obstacles in the work area. Route planning software running on the computer of the target vehicle predicts the routes of other vehicles and obstacles in the work area. The route plan of the target vehicle is updated to avoid other vehicles and obstacles in the work area. The method repeats, providing continuous updates to the target vehicle while the route plan is being executed.

In another embodiment, a method for proximity based pausing of autonomous vehicles is provided. A plurality of vehicles, each equipped with a computer, GNSS unit, and communication system, is provided. A route plan is executed by a target vehicle that is implementing the method. The target vehicle receives the locations of other vehicles in the work area. Route planning software running on the computer of the target vehicle calculates the distances between the target vehicle and other vehicles in the work area. If the distance between any two vehicles in the work area falls below a threshold, the operation of both vehicles is paused, the route plan for each vehicle is reviewed and may be updated, and one or both vehicles are manually resumed if an operator determines that it is safe to do so.

### BRIEF DESCRIPTION OF DRAWINGS

Having thus described the invention in general terms, reference will now be made to the accompanying drawings, which are not necessarily drawn to scale, and wherein:

FIG. 1 illustrates a typical tractor and planter arrangement.

FIG. 2 illustrates a method for autonomously moving a vehicle between disjoint work areas in accordance with an embodiment of the invention.

FIG. 3 illustrates a system for providing real-time navigation updates based on moving obstacles in a work area in accordance with an embodiment of the invention.

FIG. 4 illustrates a method for providing real-time navigation updates based on moving obstacles in a work area in accordance with an embodiment of the invention.

FIG. 5 illustrates a method for proximity based pausing of autonomous vehicles in accordance with an embodiment of the invention.

FIG. 6 illustrates a method for providing real-time navigation updates based on moving obstacles in a work area with proximity based pausing in accordance with an embodiment of the invention.

### DETAILED DESCRIPTION OF THE INVENTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus are not shown in one or more of the figures for clarity and to facilitate explanation of embodiments of the present invention.

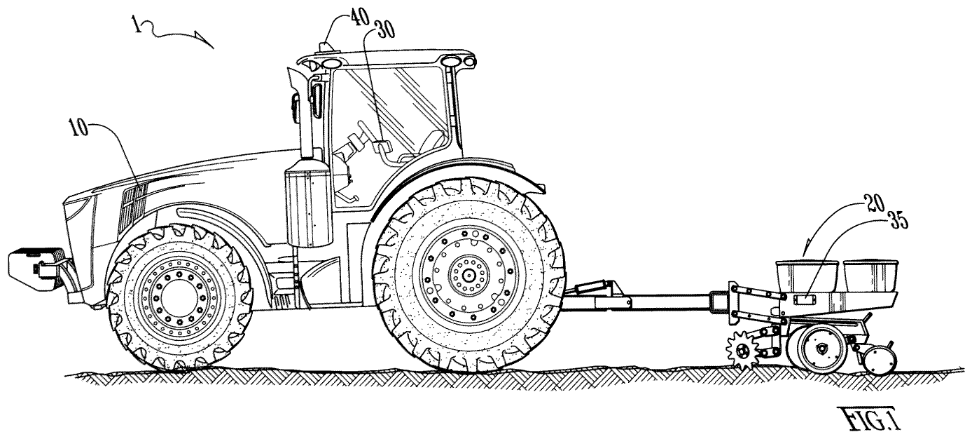

In accordance with one embodiment, FIG. 1 illustrates a typical arrangement 1 of an agricultural vehicle 10. The agricultural vehicle may comprise a tractor, sprayer, combine, or other vehicle capable of performing agricultural work operations. The agricultural vehicle 10 may have an implement 20 coupled to it. Implement 20, if present, is coupled to the vehicle 10 using either a drawbar or three-point hitch. The agricultural vehicle 10 may be a manned or autonomous vehicle. Agricultural vehicle 10 may alternatively be called vehicle 10 or tractor 10 without departing from the scope of the disclosure.

A monitor 30 mounted on the vehicle 10 communicates with various systems of vehicle 10 and implement 20. For example, monitor 30 is configured to receive and transmit signals to the CAN bus, engine control unit (ECU), and other systems of vehicle 10. Monitor 30 also communicates with a GPS unit 40 mounted to vehicle 10. GPS unit 40 may alternatively be referred to as a GNSS unit 40 without departing from the scope of the disclosure. Monitor 30 may be a tablet, laptop, or commercially available display for use in agricultural vehicles. GPS unit 40 is configured to receive satellite signals indicating the precise location of the GPS unit 40 and vehicle 10. Software running on monitor 30 is configured to control many aspects of the arrangement 1. For example, using location information from the GPS unit 40, software running on monitor 30 can control the movement of vehicle 10, raising and lowering of the implement 20, application rates performed by the implement 20, or any other aspect of controlling the implement 20 to perform a work operation. Software running on monitor 30 is also configured to record data regarding the operation of the vehicle 10 and implement 20, including the path driven by vehicle 10, application rates performed by the implement 20 throughout each worked field, and data generated by various sensors mounted to the vehicle 10 or implement 20.

A microprocessor 35 mounted on implement 20 is electronically connected to any sensors mounted on the implement 20. Microprocessor 35 is configured to receive signals from any attached sensors and perform processing to determine if sensor readings are within acceptable ranges. Microprocessor 35 is also configured to receive and transmit signals to the monitor 30. If microprocessor 35 detects an abnormal sensor reading, then that information is transmitted to monitor 30, and the vehicle 10 or implement 20 can be stopped or other remediation measures can be taken. Throughout this disclosure, any processing of sensor signals may be performed on either monitor 30 or microprocessor 35. In a typical implement 20, simple processing tasks are performed by microprocessor 35, and readings and results captured by microprocessor 35 are communicated to monitor 30 for further processor or other action.

One or more of the path plans described in the various embodiments of the disclosed methods may be created, modified, or stored on board the vehicle 10, implement 20, for example on monitor 30 or microprocessor 35. One or more path plans described in the disclosed methods may alternatively be created, modified, or stored in an off-board environment such as a separate computer or server where relevant information is processed stored, or otherwise accessed.

### Autonomously Moving a Vehicle 10 Between Disjoint Work Areas

A method 200 for moving a vehicle 10 between disjoint fields provides a self-governing transit system for vehicles 10 that specifically focuses on the efficiency and safety challenges associated with moving equipment between fields. A mission or path plan is usually defined for one field or for a transit from one field to another. A starting point and ending point are required.

Existing mission or path planning methods do not allow for creating different mission plans to stitch up a day's worth of effort. The method 200 creates a mission queue containing a number of missions to be completed, allowing vehicles 10 to move from one field to another without the need of human intervention. This is achieved using advanced path planning methods that use a combination of real time data and pre-recorded routes. For example, a user may create a mission queue containing a first mission plan to work a first field at 5 mph, a second mission plan to transport the vehicle 10 at 3 mph from the ending point of the first mission plan in the first field to a starting point of a third mission plan in a second field, where the third mission plan in the second field is worked at 4 mph. Additional mission plans or differing start points, end points, or speeds may be incorporated into the various mission plans that make up a mission queue without departing from the scope of the disclosure. While the vehicles 10 executing a mission queue typically operate autonomously, an on-site or remote operator may monitor and intervene while autonomously operating vehicles 10 execute a mission queue.

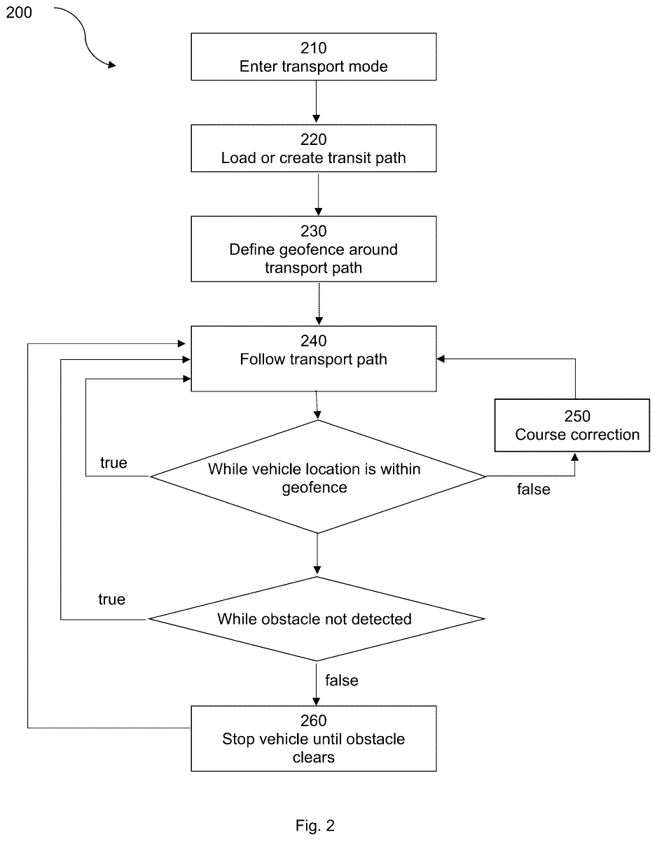

As shown in FIG. 2, a method 200 for moving a vehicle 10 between disjoint fields begins at step 210 with entering transport mode. Upon completing a mission plan contained in a mission queue, the vehicle 10 will need to move from ending point of the completed mission plan to the starting point of another mission plan in the mission queue. When a vehicle 10 needs to move from one work area to another, the vehicle automatically enters into transport mode. If present, the implement 20 associated with the vehicle 10 is secured. For example, the implement 20 is raised, inputs from the implement 20 are shut off, and booms or other folding parts of the implement 20 are retracted and secured for transport.

At step 220, a pre-recorded transit path or transport path may be loaded. Prior to the work operation, a human operator records a transit path that the vehicle 10 must travel between the two work areas. Once recorded, the transit path becomes part of the navigation system running on the computer 30 of the vehicle 10. For future transports, the pre-recorded transit path serves as a blueprint, thereby ensuring navigation efficiency and uniformity. At step 220, the required pre-recorded transit path is retrieved from the navigation system and loaded such that the navigation system running on the computer 30 can follow the pre-recorded transit path. Alternatively, instead of pre-creating a number of missions in the mission queue, the mission queue may contain the goal or intent of each mission plan, for example defining an area of land and a work operation to be performed on the area of land, and allowing path creation, path ordering, and speed to be dynamically planned in a “just in time” manner. By dynamically creating a mission plan, the order of the fields to be worked can be changed at any time by an operator monitoring completion of the mission queue In addition, dynamically created plans allows for a vehicle 10 to continue executing the mission queue if the vehicle 10 does not stop precisely at a pre-defined end point of a particular mission plan or otherwise departs from the pre-recorded plan. In such an embodiment, a transit path is dynamically created at step 220.

At step 230, a geofence is defined around the pre-recorded or dynamically created transit path. A geofence is constructed as a buffer zone around the transit path incorporating a tolerance level to allow for minor deviations from the transit path, such as to avoid obstacles. During transport along the transit path, the vehicle 10 remains within the operational safe zone defined by the geofence that is set at step 230.

At step 240, the vehicle 10 begins to follow the transit path. The location of the vehicle 10 is monitored by retrieving the location of the vehicle 10 using the GNSS system 40 and determining if the vehicle 10 is within the geofence defined at step 230. The transit path loaded at step 220 is followed by navigation software running on the computer 30 while the vehicle 10 is within the geofence defined at step 230. If the vehicle 10 strays outside the geofence defined at step 230, course correction is applied at step 250. Course correction may be applied automatically at step 250 without human intervention. If autonomous course correction at step 250 is successful, the vehicle continues to follow the transit path loaded at step 220 is followed by navigation software running on the computer 30 while the vehicle 10 is within the geofence defined at step 230. If autonomous course correction at step 250 is not possible, the vehicle 10 is stopped and human intervention is required before the vehicle 10 is allowed to resume following the transit path.

The vehicle 10 continues to follow the transit path at step 240, correcting course at step 250 as necessary and continuously performing obstacle detection while no obstacles are detected. At step 260, an obstacle has been detected, the vehicle 10 is stopped, and situational assessment is performed. In the situational assessment, the navigation system running on computer 30 uses input from sensors mounted on the vehicle 10 to determine if it is safe to proceed with following the transport path. If the navigation software does not detect any safety issues during the situational assessment, the vehicle 10 proceeds along the transit path and into the new work area. If the navigation software determines that the transit path cannot be executed safely, the vehicle 10 pauses and waits for human intervention.

### Providing Real-Time Navigation Updates Based on Moving Obstacles in a Work Area

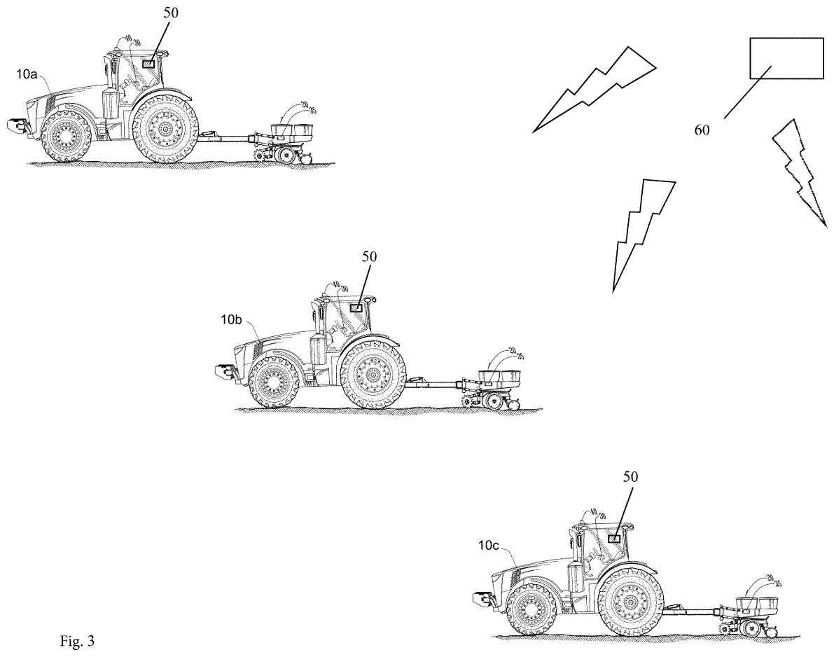

As shown in FIG. 3, a plurality of work vehicles 10 may operate in a work area to perform a work operation. For purposes of illustration, the individual vehicles 10 are denoted vehicle 10a, vehicle 10b, and vehicle 10c when referred to individually and vehicles 10 when referred to collectively. While three vehicles 10 are shown in FIG. 3 and described in this section of the disclosure, any number of vehicles 10 may be working in the work area without departing from the scope of the disclosure. Each vehicle 10 may be towing an implement 20.

Each vehicle 10 is equipped with a GNSS unit 40 to provide the geographic location of the vehicle 10 and a computer 30 or microprocessor 35. A GNSS unit 40 is installed on any critical or moving obstacle in the work area. The GNSS unit 40 continuously transmits the exact location of the vehicle 10 or other obstacles.

Navigation software running on the computer 30 or microprocessor 35 associated with each vehicle 10 uses the real time location of the vehicle 10 along with a route planning algorithm to steer the vehicle 10, control speed of vehicle 10, control implement 20 operation, and perform other functions related to vehicle 10 and implement 20. The route planning algorithm incorporates real-time data and predictions from the computer 30 or microprocessor 35 to dynamically plan routes of autonomous vehicles 10 or devices. The route planning algorithm uses predicted vehicle 10 speeds, operating limits, and obstacle speeds to optimize performance and safety.

A central communication system 60 provides communication between the vehicles 10 via vehicle communication system units 50 that are installed on each vehicle 10. The central communication system 60 provides seamless data exchange between GNSS units 40, computers 30, microprocessors 35, and autonomous vehicles 10 or devices, enabling real-time adaptation and forecasting. The central communication system 60 receives data from the GNSS units 40 on each obstacle, processes their current locations, and determines future positions based on movement and speed. Such communication allows for adjusting the route of a target vehicle 10 in order to avoid collisions between vehicles 10 and to increase efficiency of the work operation by avoiding overlapping paths. The vehicle communication system units 50 may comprise internet-connected modems or other similar devices configured to transmit and receive data. Through its vehicle communication system unit 50, each vehicle 10 may communicate with the communication system 60, which may comprise a server or similar hardware configured to transmit data to and receive data from vehicles 10, thus coordinating communication between the vehicles 10. The communication system 60 may comprise hardware located onsite at the work area or a remote server. Alternatively the vehicles 10 may communicate directly to each other via their vehicle communication system units 50.

A method 400 for providing real-time navigation updates based on moving obstacles in a work area provides increased safety and efficiency by updating vehicle 10 routes based on the predicted travel paths of other vehicles 10 moving in the work area. For purposes of example, the method 400 will be described for vehicles 10a, 10b, and 10c as shown in FIG. 3; however, any number of vehicles 10 could be used without departing from the scope of the disclosure. In the example described, vehicle 10a is the target whose path is being updated by the method 400 and vehicles 10b and 10c are other obstacles working in the work area.

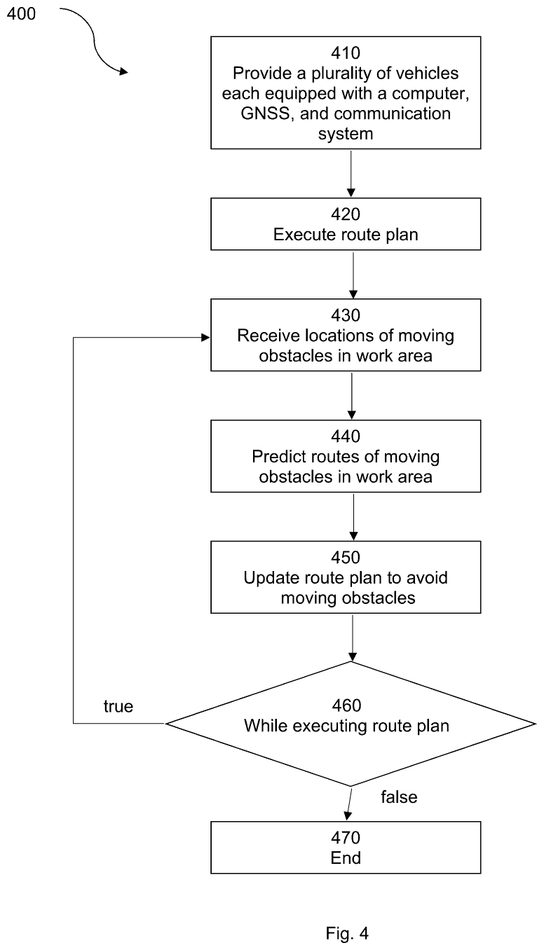

As shown in FIG. 4, the method 400 begins at step 410 with providing a plurality of vehicles 10, each equipped with a computer 30, GNSS unit 40, and vehicle communication system unit 50. The vehicles 10 may be as previously described in this section. In the illustrated example, vehicles 10a, 10b, and 10c are provided at step 410 to perform a work operation in the work area.

At step 420, navigation software operating on the computer 30 of vehicle 10a executes a route plan for vehicle 10a. The route planning algorithm steers the vehicle 10a, controls the speed of vehicle 10a, controls the operation of any implement 20 associated with vehicle 10a, and performs any other functions related to vehicle 10a and its associated implement 20.

At step 430, the locations of other vehicles 10 or other obstacles in the work area are received by the target vehicle 10. In the illustrated example, target vehicle 10a receives the locations of vehicles 10b and 10c. The locations of vehicles 10b and 10c are determined by the GNSS unit 40 of vehicles 10b and 10c, communicated via the central communication system 60 and vehicle communication system units 50, and received by the route planning algorithm running on the computer 30.

At step 440, the routes of other vehicles 10 or other obstacles in the work area are predicted. In the illustrated example, the route planning algorithm running on the computer 30 of vehicle 10a predicts the speed and direction of travel of vehicles 10b and 10c based on the location received at step 430 and previous locations of vehicles 10b and 10c which were previously received.

At step 450, the route plan is updated to avoid other vehicles 10 and obstacles in the work area. In the illustrated example, the route plan of vehicle 10a is adjusted based on the routes of vehicles 10b and 10c predicted at step 440.

At step 460, steps 430-450 are repeated as long as the route plan is being executed. When execution of the route plan ends, the method 400 ends at step 470 While the route of vehicle 10a is illustrated, the method 400 may be simultaneously executed by vehicles 10b and 10c, with each vehicle 10 receiving location information for the other vehicles 10 and other obstacles in the work area while executing its respective route plan.

### Proximity Based Pausing of Autonomous Vehicles

When a number of vehicles 10 are operating autonomously or are being controlled remotely, collisions between vehicles 10 may occur. A method 500 for proximity based pausing of autonomous vehicles may avoid such collisions, avoiding damage and lost working time.

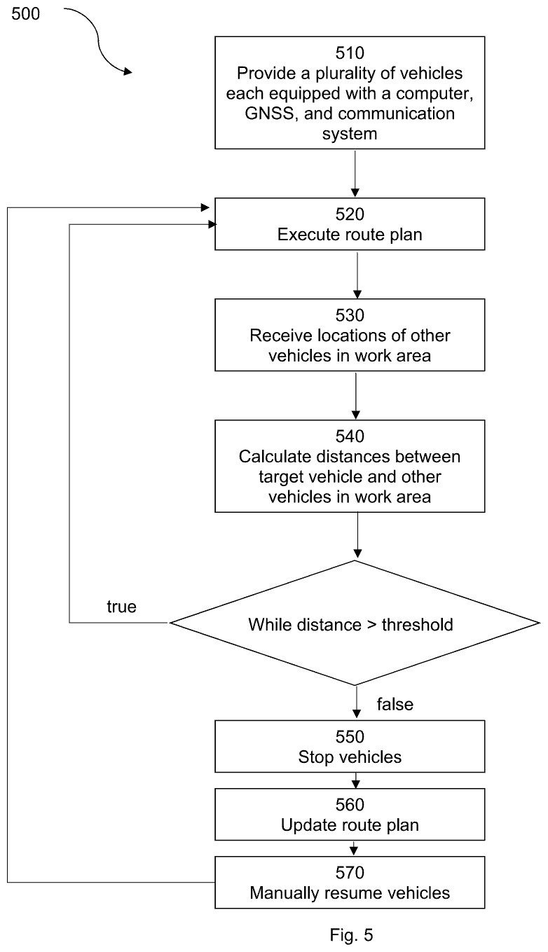

As shown in FIG. 5, a method 500 for proximity based pausing of autonomous vehicles begins at step 510 with providing a plurality of vehicles 10, each equipped with a computer 30 or microprocessor 35, GNSS unit 40, and vehicle communication system unit 50. The vehicles 10 may be as shown in FIG. 3 and as described in the section entitled “Providing real-time navigation updates based on moving obstacles in a work area.” In the illustrated example, vehicles 10a, 10b, and 10c are provided at step 510 to perform a work operation in the work area; however, any number of vehicles 10 may be used without departing from the scope of the disclosure.

Throughout the description of the method 500, the work vehicles 10 may be referred to collectively as vehicles 10 or individually as vehicles 10a, 10b, and 10c. While method 500 is described in the context of vehicles 10 in a work area, the method 500 may also be used with other types of moving obstacles.

At step 520, navigation software operating on the computer 30 of vehicle 10a executes a route plan for vehicle 10a. The route planning algorithm steers the vehicle 10a, controls the speed of vehicle 10a, controls the operation of any implement 20 associated with vehicle 10a, and performs any other functions related to vehicle 10a and its associated implement 20. As a further precaution, the navigation software may only allow a vehicle 10 to execute its route plan when the vehicle 10 has an authenticated connection to the central communication system 60.

At step 530, the locations of other vehicles 10 in the work area are received by the target vehicle 10. In the illustrated example, target vehicle 10a receives the locations of vehicles 10b and 10c. The locations of vehicles 10b and 10c are determined by the GNSS unit 40 of vehicles 10b and 10c, communicated via the central communication system 60 and vehicle communication system units 50, and received by the route planning algorithm running on the computer 30.

At step 540, the distances between the target vehicle 10 and the other vehicles 10 in the work area are calculated. In the illustrated example, target vehicle 10a calculates the distances between itself and the other vehicles 10b and 10c using the current location of target vehicle 10a received from the GNSS unit 40 of target vehicle 10a and the locations of vehicles 10b and 10c received at step 530. This calculation is performed by the route planning algorithm running on the computer 30 of vehicle 10a. The distances calculated at step 540 are compared to a threshold. Step 520 execution of the route plan, step 530 receiving locations of the other vehicles 10b and 10c, and step 540 calculation of distances between vehicles 10 are repeated as long as the distances calculated at step 540 exceed the threshold. In one embodiment, the threshold may be 20 meters to allow the vehicles 10 to continue operating according to the route plan of each vehicle 10 as long as separation between vehicles is at least 20 meters; however, other thresholds may be used without departing from the scope of the disclosure.

At step 550, operation of affected vehicles 10 is stopped if any distance calculated at step 540 is determined to be less than or equal to the threshold. For example, if the distance between vehicles 10a and 10b is determined at step 540 to be 19 meters, then the operation of vehicles 10a and 10b is stopped. A notification such as a text message indicating that vehicles 10a and 10b are too close to each other is sent to a system user, who may be a remote operator monitoring and intervening in the operation of the vehicles 10 when necessary.

At step 560, the route plan is updated to avoid other vehicles 10 in the work area. In the illustrated example, the route plans of vehicles 10a or 10b or both may be adjusted to increase the distance between vehicles 10a and 10b and avoid additional alerts based on insufficient distance between vehicles 10a and 10b. Updating the route plan at step 560 may be performed manually by the system user; alternatively, the navigation software may implement an alternative route for one or both affected vehicles 10.

At step 570, the system user may manually resume operation of one or both of the paused vehicles 10 if the system user determines that it is safe to do so. One resumed, the resumed vehicles 10 return to step 520, execution of the route plan, and the method 500 continues as described until the work operation is completed or stopped.

### Combining Methods 400 and 500

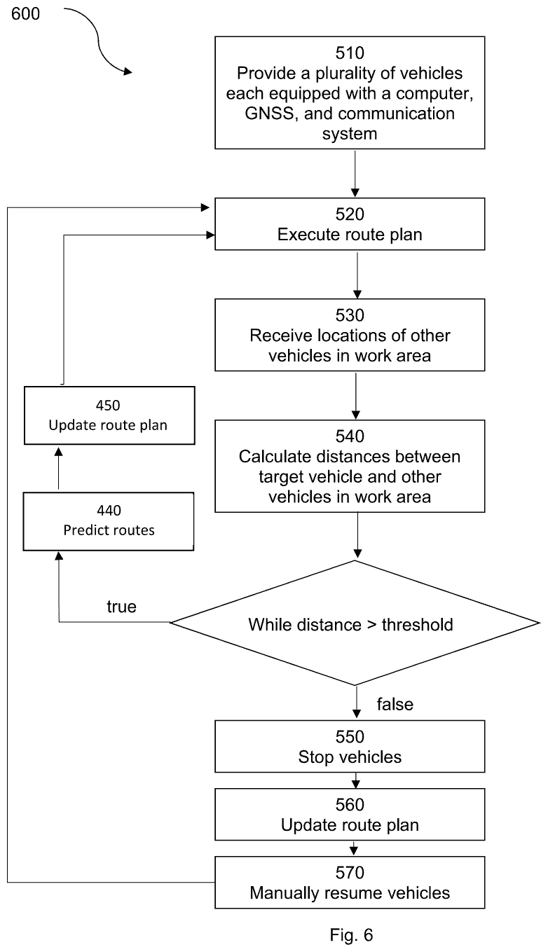

The methods 400 and 500 have many similarities and have similar goals of avoiding damage and improving efficiency during a work operation. Ideally, when method 400 is executed, the minimum distance threshold will be satisfied. As shown in FIG. 6, the methods 400 and 500 may be combined into a method 600 such that route plans are continually updated as in method 400, but vehicles may be paused and manually resumed as in method 500 if minimum distances are not maintained despite efforts to route vehicles 10 to avoid proximity exceptions using method 400. The method 600 begins at step 510 with providing a plurality of vehicles 10, each equipped with a computer 30 or microprocessor 35, GNSS unit 40, and vehicle communication system unit 50. The vehicles 10 may be as shown in FIG. 3 and as described in the section entitled “Providing real-time navigation updates based on moving obstacles in a work area.” In the illustrated example, vehicles 10a, 10b, and 10c are provided at step 510 to perform a work operation in the work area; however, any number of vehicles 10 may be used without departing from the scope of the disclosure. Throughout the description of the method 500, the work vehicles 10 may be referred to collectively as vehicles 10 or individually as vehicles 10a, 10b, and 10c. While method 500 is described in the context of vehicles 10 in a work area, the method 500 may also be used with other types of moving obstacles.

At step 520, navigation software operating on the computer 30 of vehicle 10a executes a route plan for vehicle 10a. The route planning algorithm steers the vehicle 10a, controls the speed of vehicle 10a, controls the operation of any implement 20 associated with vehicle 10a, and performs any other functions related to vehicle 10a and its associated implement 20. As a further precaution, the navigation software may only allow a vehicle 10 to execute its route plan when the vehicle 10 has an authenticated connection to the central communication system 60.

At step 530, the locations of other vehicles 10 in the work area are received by the target vehicle 10. In the illustrated example, target vehicle 10a receives the locations of vehicles 10b and 10c. The locations of vehicles 10b and 10c are determined by the GNSS unit 40 of vehicles 10b and 10c, communicated via the central communication system 60 and vehicle communication system units 50, and received by the route planning algorithm running on the computer 30.

At step 540, the distances between the target vehicle 10 and the other vehicles 10 in the work area are calculated. In the illustrated example, target vehicle 10a calculates the distances between itself and the other vehicles 10b and 10c using the current location of target vehicle 10a received from the GNSS unit 40 of target vehicle 10a and the locations of vehicles 10b and 10c received at step 530. This calculation is performed by the route planning algorithm running on the computer 30 of vehicle 10a. The distances calculated at step 540 are compared to a threshold. As long as all distances exceed the threshold, work may continue, and the method 600 proceeds to steps 440 and 450, which proceed as described in the section titled “Providing real-time navigation updates based on moving obstacles in a work area.” Step 440 predicting routes of moving obstacles, step 450 updating route plan to avoid moving obstacles, step 520 execution of the route plan, step 530 receiving locations of the other vehicles 10b and 10c, and step 540 calculation of distances between vehicles 10 are repeated as long as the distances calculated at step 540 exceed the threshold. In one embodiment, the threshold may be 20 meters to allow the vehicles 10 to continue operating according to the route plan of each vehicle 10 as long as separation between vehicles is at least 20 meters; however, other thresholds may be used without departing from the scope of the disclosure.

At step 550, operation of affected vehicles 10 is stopped if any distance calculated at step 540 is determined to be less than or equal to the threshold. For example, if the distance between vehicles 10a and 10b is determined at step 540 to be 19 meters, then the operation of vehicles 10a and 10b is stopped. A notification such as a text message indicating that vehicles 10a and 10b are too close to each other is sent to a system user, who may be a remote operator monitoring and intervening in the operation of the vehicles 10 when necessary.

At step 560, the route plan is updated to avoid other vehicles 10 in the work area. In the illustrated example, the route plans of vehicles 10a or 10b or both may be adjusted to increase the distance between vehicles 10a and 10b and avoid additional alerts based on insufficient distance between vehicles 10a and 10b. Updating the route plan at step 560 may be performed manually by the system user; alternatively, the navigation software may implement an alternative route for one or both affected vehicles 10.

At step 570, the system user may manually resume operation of one or both of the paused vehicles 10 if the system user determines that it is safe to do so. One resumed, the resumed vehicles 10 return to step 520, execution of the route plan, and the method 500 continues as described until the work operation is completed or stopped.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for autonomously moving a vehicle between a first work area and a second work area comprising:
causing the vehicle to enter a transport mode;
loading a transit path between the first work area and the second work area;
defining a geofence around the transit path;
executing the transit path;
course correcting the vehicle if a location of the vehicle is outside the geofence;
pausing movement of the vehicle if an obstacle is encountered;
performing situational assessment; and
resuming execution of the transit path based on the situational assessment.

2. The method of claim 1 wherein causing the vehicle to enter a transport mode comprises securing an implement associated with the vehicle.

3. The method of claim 1 wherein performing situational assessment comprises obstacle detection.

4. A method for providing real-time navigation updates for a vehicle based on moving obstacles in a work area comprising:
providing a plurality of vehicles, each of the plurality of vehicles equipped with a computer, a GNSS unit, and a communication system;
executing a route plan using the computer of a first vehicle;
receiving at the computer of the first vehicle a location of each other vehicle in the work area;
predicting a speed and trajectory of each other vehicle in the work area using the location of each other vehicle in the work area; and
updating the route plan of the first vehicle.

5. A method for proximity based pausing of autonomous vehicles in a work area comprising:
providing a first vehicle and at least one additional vehicle, each equipped with a computer, a GNSS unit, and a communication system;
executing a route plan using the computer of the first vehicle;
receiving at the computer of the first vehicle a location of the at least one additional vehicle;
calculating a distance between the first vehicle and the at least one additional vehicle;
pausing the first vehicle and the at least one additional vehicle if the distance between the first vehicle and the at least one additional vehicle is less than or equal to a threshold;
updating the route plan using the computer of the first vehicle; and
manually resuming operating of the first vehicle.

6. The method of claim 5 further comprising resuming operating the at least one additional vehicle.

7. The method of claim 5 wherein updating the route plan comprises creating an updated route plan for execution by the first vehicle such that the distance between the first vehicle and the at least one additional vehicle exceeds the threshold.
